(19) United States
(12) Patent Application Publication
(10) Pub. No.: US 2014/0172921 A1
(43) Pub. Date: Jun. 19, 2014

(54) INFORMATION PROCESSING APPARATUS AND INFORMATION PROCESSING METHOD

(71) Applicant: Fuji Xerox Co., Ltd., Tokyo (JP)

(72) Inventors: Nobuyuki KUTOH, Yokohama-shi (JP); Takayuki SAITO, Yokohama-shi (JP)

(21) Appl. No.: 13/912,371

(22) Filed: Jun. 7, 2013

(30) Foreign Application Priority Data
Dec. 18, 2012 (JP) 2012-275247

(51) Int. Cl. G06F 17/30

(52) U.S. Cl. CPC G06F 17/3012
USPC 707/803

(57) ABSTRACT

There is provided an information processing apparatus. A receiver receives designations of: a first attribute from among attributes relating to a paper on which an image is to be printed, in a stored attribute file; a range within which a value of the first attribute could be; and an increase or decrease width of the value. A first attribute generator generates attribute values for the first attribute, obtained by increasing or decreasing the value at the increase or decrease width within the range. A file generator generates attribute files, each of which includes each of the generated attribute values of the first attribute. An attribute value of a second attribute, which has not been designated, in the generated attribute files is the same with an attribute value of the second attribute in the attribute file.

### CROSS-REFERENCE TO RELATED APPLICATIONS

This application is based on and claims priority under 35 U.S.C. §119 from Japanese Patent Application No. 2012-275247 filed on Dec. 18, 2012.

### TECHNICAL FIELD

The present invention relates to an information processing apparatus and an information processing method.

### SUMMARY

According to an aspect of the exemplary embodiments of the present invention, there is provided an information processing apparatus comprising: a memory that stores an attribute file which includes a plurality of attributes relating to a paper on which an image is to be printed; a receiver that receives designations of: a first attribute from among the plurality of attributes in the stored attribute file; a range within which a value of the first attribute could be; and an increase or decrease width of the value; a first attribute generator that generates a plurality of attribute values for the first attribute, the attribute values obtained by increasing or decreasing the value at the increase or decrease width within the range; and a file generator that generates a plurality of attribute files, each of the generated attribute files includes each of the plurality of generated attribute values of the first attribute, wherein an attribute value of a second attribute, which has not been designated, in the plurality of generated attribute files is the same with an attribute value of the second attribute in the attribute file.

### BRIEF DESCRIPTION OF THE DRAWINGS

Exemplary embodiments of the present invention will be described in detailed based on the following figures, wherein:

FIG. 1 is a conceptual module configuration view relative a configuration example of an exemplary embodiment;

FIG. 2 is a flow chart illustrating a process example according to the exemplary embodiment;

FIG. 3 is another flow chart illustrating the process example according to the exemplary embodiment;

FIG. 4 is explanatory view illustrating an example of a base file selection screen which the exemplary embodiment displays;

FIG. 5 is an explanatory view illustrating an example of an option parameter selection screen which the exemplary embodiment displays;

FIG. 6 is an explanatory view illustrating an example of an option-parameter-designating-method selection screen which the exemplary embodiment displays;

FIG. 7 is an explanatory view illustrating an example of the data structure of a paper attribute table;

FIG. 8 is an explanatory view illustrating an example of a setting screen which the exemplary embodiment displays;

FIG. 9 is an explanatory view illustrating an example of an additional-parameter selection screen which the exemplary embodiment displays; and

FIG. 10 is a block diagram illustrating an example of the hardware configuration of a computer implementing the exemplary embodiment.

### DETAILED DESCRIPTION

Hereinafter, examples of an exemplary embodiment appropriate for implementing the present invention will be described on the basis of the accompanying drawings.

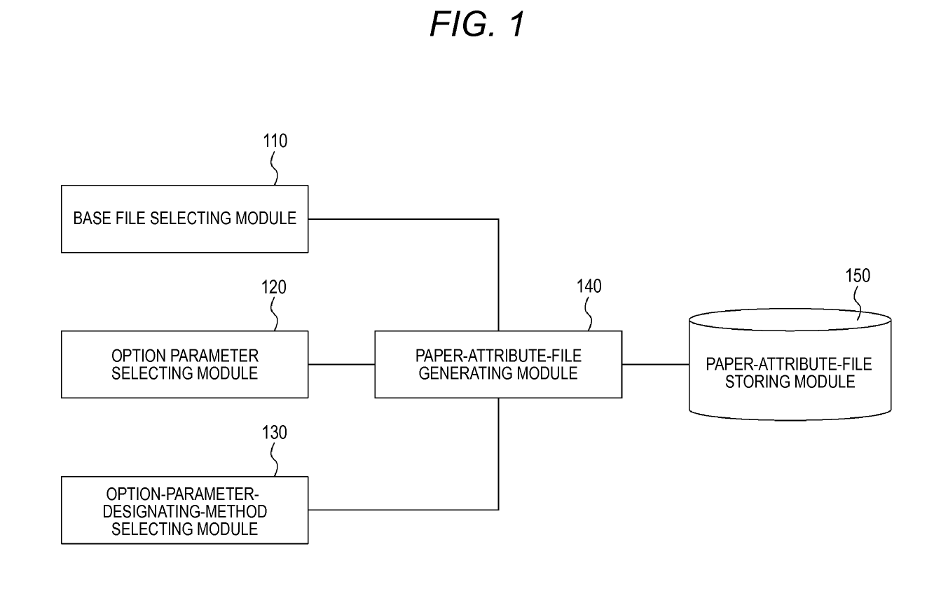

FIG. 1 shows a conceptual module configuration view relating to an example of the configuration of the exemplary embodiment.

In general, the word module refers to a software component that is logically separable (a computer program), a hardware component, or the like. The module of the exemplary embodiment refers to not only a module in a computer program but also a module in a hardware configuration. Therefore, the description of the exemplary embodiment also serves as the description of a computer program (program for causing a computer to execute steps, program for causing a computer to function as units, program for causing a computer to realize functions), a system and method for functioning as the modules. However, for the convenience of the description, the phrases “stores information,” “causes information to be stored,” and other phrases equivalent thereto are used, however, if the exemplary embodiment is a computer program, these phrases are intended to express “causes a memory device to store information” or “controls a memory device to cause the memory device to store information.” Modules may be in a one-to-one correspondence with functions; however, in implementation, one module may be composed of one program or two or more modules may be composed of one program or two or more programs may be composed of one module. Two or more modules may be executed by one computer or one module may be executed in two or more computers in a distributed or parallel environment. One module may contain any other module. In the description to follow, the term “connection” is used to mean not only physical connection, but also logical connection (such as an exchange of data, instructions, and data reference relationship). The word “predetermined” means that something is decided in advance of a process of interest. The word “predetermined” is thus intended to refer to something that is decided in advance of a process of interest in the exemplary embodiment. Even after a process in the exemplary embodiment has started, the word “predetermined” refers to something that is decided in advance of a process of interest depending on a condition or a status of the exemplary embodiment at the present point of time or depending on a condition or status heretofore continuing down to the present point of time. In a case where there is a plurality of “predetermined values”, the predetermined values may be different from one another, and two or more predetermined values may be the same. A statement that reads “If A, B is performed” is used to convey the meaning that it is determined whether condition A is satisfied, and that if the condition A is satisfied, B is performed. This statement is not applicable if the determination as to whether the condition A is satisfied or not is unnecessary.

The word “system” and the word “apparatus” refer to an arrangement where multiple computers, a hardware structure, and an apparatus are interconnected via a communication network (including a one-to-one communication connection). The word “system” and the word “apparatus” also refer to an arrangement that includes a single computer, a hardware structure, or an apparatus. The word “system” and the word “apparatus” have the same definition and are interchangeable with each other. The system in the context of the exemplary embodiment does not include a social system that is a social arrangement formulated by humans.

Target information is read from a memory device for each processing by each module or for each processing if a plurality of types of processing is performed in a module, and after the processing is performed, the processing result is written to a memory device. Therefore, description of read from a memory device before processing and write to a memory device after processing may be omitted. The memory device may contain a hard disk, a random access memory (RAM), an external storage medium, a storage connected through a communication line, registers in a central processing unit (CPU), etc.

An information processing apparatus according to the exemplary embodiment generates information on paper attributes, and stores the information as a file in a memory device, and includes a base file selecting module 110, an option parameter selecting module 120, an option-parameter-designating-method selecting module 130, a paper-attribute-file generating module 140, and a paper-attribute-file storing module 150, as shown in FIG. 1. For example, the information processing apparatus may be used for a copy machine, a facsimile, a printer, a multi-function apparatus (an image processing apparatus having two or more of the functions of a scanner, a printer, a copy machine, a facsimile, etc.), and so on. Here, paper attribute (which will hereinafter be referred to as an option parameter) information (which will also be referred to as a paper attribute file or a stock file) is information on paper attributes which are set with respect to paper feeding unit (including, for example, a tray).

The paper attribute information is used as follows. First, with respect to papers stored in the paper feeding unit, attribute information relating to the papers are assigned to the paper feeding unit. Then, if printing is performed, a paper feeding unit corresponding to the attributes of papers designated during printing is selected. Next, the paper attributes assigned to the selected paper feeding unit are used to perform printing at an image quality appropriate for papers stored in the selected paper feeding unit.

Multi-function apparatuses include some models which need to generate a paper attribute file before performing printing, as described above. Now, paper attribute file generation different from the exemplary embodiment will be described.

Paper attribute file generation is performed from a touch panel of a multi-function apparatus, and it takes about several minutes (about 5 minutes on average) to generate one paper attribute file, and more time is taken in a case of performing even detailed setting such as paper curl correction and fold position adjustment.

In a case of generating a plurality of paper attribute files, further more time is taken. For example, in a case where the paper size is fixed and N-number of paper attribute files different only in the paper curls are generated, N-number of substantially same operations should be performed. Further, in the case of performing even detailed setting, a time necessary for paper attribute file generation increases.

Also, these paper attribute files can be opened and be directly edited by means of a text editor. However, in the case of file editing, there is a possibility that an artificial mistake will happen. Also, in a case of editing a paper attribute file by means of a text editor, since there is no function to check for errors in the contents of the paper attribute file, it is impossible to ensure a set operation in a multi-function apparatus or the like.

The base file selecting module 110 is connected to the paper-attribute-file generating module 140. The base file selecting module 110 selects a file (hereinafter, referred to as a base file) to be a basis for a paper attribute file to be generated by the paper-attribute-file generating module 140. In this case, the base file selecting module 110 may select a base file according to the operation of a user on a mouse, a keyboard, a touch panel, or the like, or may select a predetermined base file. Also, the option parameter selecting module 120 and the option-parameter-designating-method selecting module 130 perform selection in the same way. For example, the base file may be a paper attribute file to be a form (template) or a paper attribute file generated in the past.

The option parameter selecting module 120 is connected to the paper-attribute-file generating module 140. The option parameter selecting module 120 selects attributes relating to papers for printing images. In other words, the option parameter selecting module 120 selects attributes to be generated by the paper-attribute-file generating module 140, from among a plurality of attributes. Examples of selectable attributes include “PAPER SIZE” (A3, A4, B4, B3, 8″×10″, postcard, etc.), “PAPER TYPE” (plain paper, OHP film, embossed paper, etc.), “PAPER COLOR” (white, gray, ivory, etc.), “PAPER COATING” (uncoated paper, coated paper, mat), “WEIGHT OF PAPER” (g/m²) (numerical values), “GRAIN” (long edge, and short edge), “NUMBER OF SHEETS OF ONE SET” (undesignated, and 2 to 255), and “PUNCH HOLE” (none, two holes, three holes, and four holes).

The option-parameter-designating-method selecting module 130 is connected to the paper-attribute-file generating module 140. The option-parameter-designating-method selecting module 130 has five methods, that is, first to fifth methods, as methods of generating attributes relating to papers for printing images. The option-parameter-designating-method selecting module 130 selects one of the first method and any one or more of the second to fifth methods.

The first method (easy designation) is to designate a range, and a decrease width or an increase width, with respect to an attribute value, and decrease or increase the attribute value in units of a corresponding width in that range, thereby generating attribute values. The first method can be used not only in a case where the attribute values are numeral values but also in a case where the attribute values are texts like “PAPER SIZE”. If the attribute values are arranged according to a predetermined rule (for example, a size order), the attribute values are sequentially selected in that order. In this case, a width “1” means sequential selection, and a width “2” means alternate selection. This is similarly defined even in the following description.

The second method (history designation) is to generate attribute values on the basis of attributes used in the past.

The third method (registration designation) is to generate attribute values using already registered attributes. In other words, a paper attribute file generated in advance is used.

The fourth method (model-dependent designation) is to generate only attribute values usable in an image printing apparatus. Examples of the image printing apparatus include even an apparatus which is called a finisher and performs a process (such as a punching process) on printed papers. Particularly, in a case where there are many attributes depending on the finisher, and there are restrictions on settable values, the fourth method can be used.

The fifth method (manual designation) is to generate attribute values in response to the operation of the user. This method is a method which has been conventionally used, and in which the user arbitrarily designates attributes.

Also, the first method is necessarily included as an alternative. As other alternatives, at least one of the second to fifth methods is included. Therefore, the number of alternatives becomes 2 to 5.

Also, for each attribute, a generating method may be selected. For example, with respect to the attribute “WEIGHT OF PAPER”, the first method (easy designation) may be selected, and with respect to the attribute “PAPER COATING”, the fifth method (manual designation) may be selected.

The paper-attribute-file generating module 140 is connected to the base file selecting module 110, the option parameter selecting module 120, the option-parameter-designating-method selecting module 130, and the paper-attribute-file storing module 150. The paper-attribute-file generating module 140 receives designation of a range that the value of each attribute relating to the papers for printing images can take, and the increase or decrease width of that value. Then, according to the received information, the paper-attribute-file generating module 140 generates attributes for each of a plurality of kinds of papers. Specifically, the paper-attribute-file generating module 140 extracts the minimum value of the range that the attribute value can take, and adds the increase width to the minimum value serving as an initial value, thereby generating the attributes of each paper. Alternatively, the paper-attribute-file generating module 140 extracts the maximum value of the range that the attribute value can take, and subtracts the decrease width from the maximum value serving as an initial value, thereby generating the attributes of each paper. Next, the paper-attribute-file generating module 140 converts the attributes generated for each paper into a file. Then, the paper-attribute-file generating module 140 stores that paper attribute file in the paper-attribute-file storing module 150.

Also, in a case where the first method is selected by the option-parameter-designating-method selecting module 130, according to the above-mentioned received information, the paper-attribute-file generating module 140 generates attributes for each of the plurality of papers. Meanwhile, in a case where any one of the second to fifth methods other than the first method is selected by the option-parameter-designating-method selecting module 130, according to the selected method, the paper-attribute-file generating module 140 generates attributes for each of the plurality of papers.

Also, the paper-attribute-file generating module 140 may generate attributes selected by the option parameter selecting module 120, with respect to each of the plurality of papers.

Also, after the paper attribute file is generated, if an attribute in the paper attribute file is changed, the paper-attribute-file generating module 140 determines whether the change of that attribute makes it necessary to change another attribute. Then, in a case of determining that it is necessary to change another attribute, the paper-attribute-file generating module 140 changes another attribute on the basis of the changed attribute.

The paper-attribute-file storing module 150 is connected to the paper-attribute-file generating module 140. The paper-attribute-file storing module 150 stores the paper attribute file generated by the paper-attribute-file generating module 140. Thereafter, in a case where the paper attribute files stored in the paper-attribute-file storing module 150 are assigned to the paper feeding unit and printing is performed as described above, a paper feeding unit corresponding to the attributes relating to papers designated during printing is selected, and a paper attribute file assigned to the paper feeding unit (the paper attributes stored in that paper attribute file) is used to perform printing at an image quality appropriate for papers stored in the selected paper feeding unit.

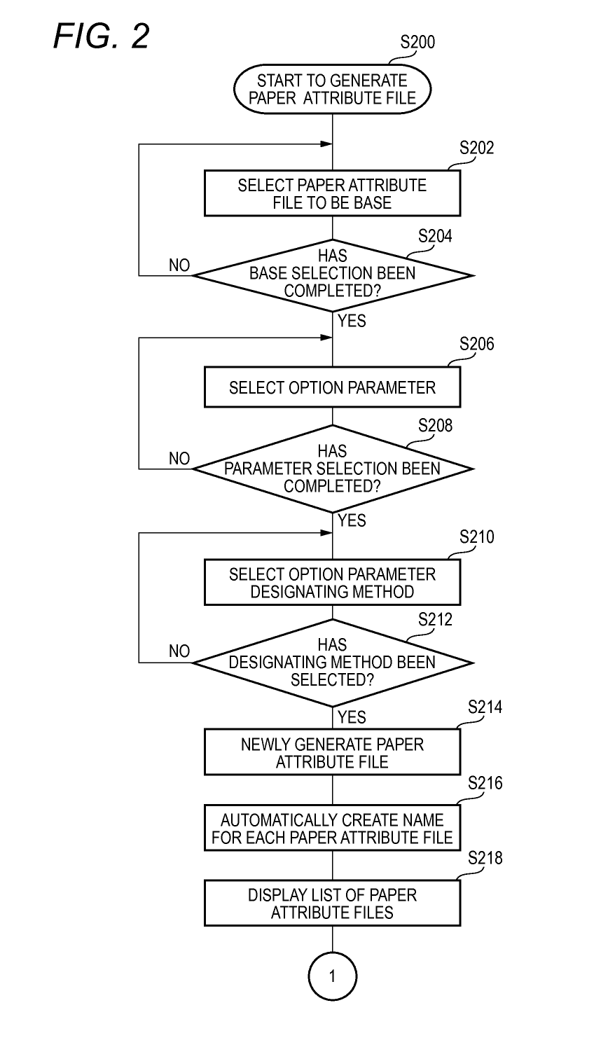

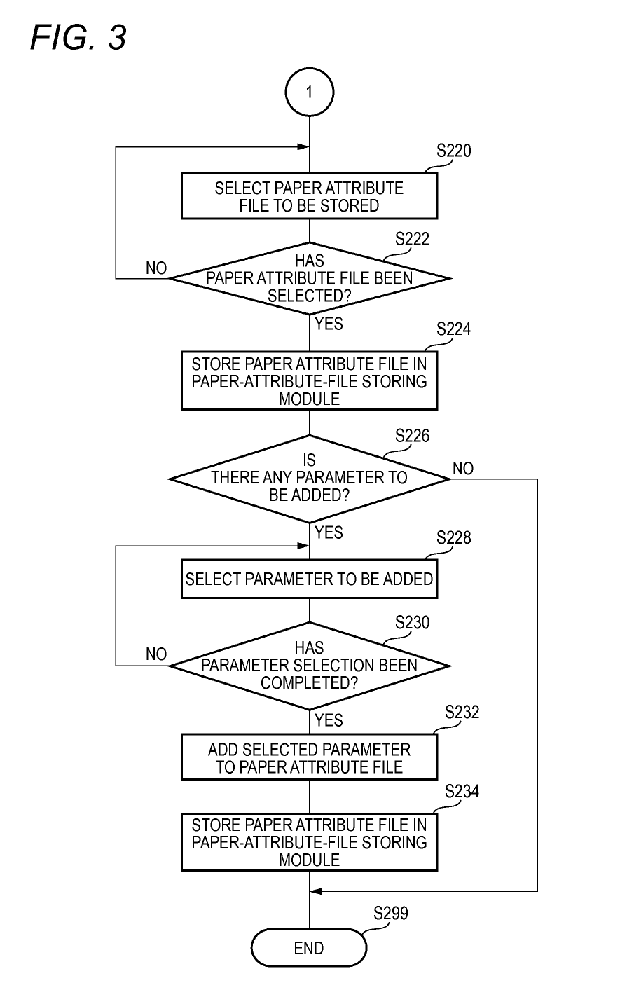

FIGS. 2 and 3 are flow charts illustrating a process example according to the exemplary embodiment.

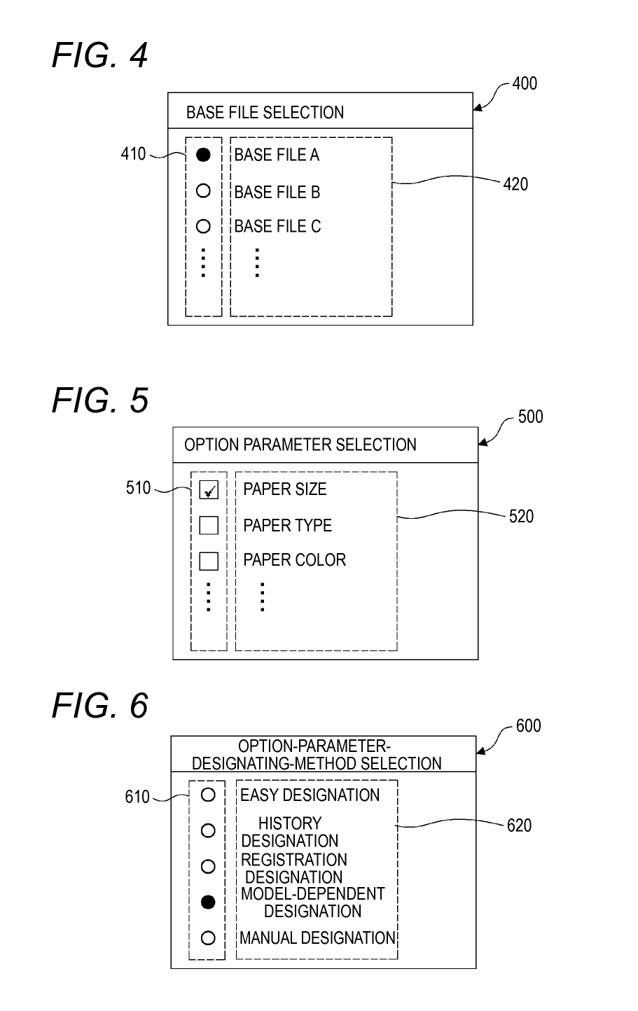

In STEP S202, the base file selecting module 110 selects a paper attribute file to be a base. For example, the base file selecting module 110 displays a base file selection screen 400 on a display unit such as a liquid crystal display. FIG. 4 is an explanatory view illustrating an example of the base file selection screen 400 which the exemplary embodiment displays. In the base file selection screen 400, a selection area 410, base file names, and an explanation area 420 are displayed. In the selection area 410, only one base file can be selected.

In STEP S204, the base file selecting module 110 determines whether the base selection has been completed. In a case where the base selection has been completed, the process proceeds to STEP S206, and otherwise, the process returns to STEP S202.

In STEP S206, the option parameter selecting module 120 selects an option parameter (attribute). Examples of the option parameter include “PAPER SIZE”, “PAPER TYPE”, a “PAPER COLOR”, “PUNCH HOLE”, etc. Also, selectable attributes may be restricted according to the model of a multi-function apparatus or the like. For example, the option parameter selecting module 120 displays an option parameter selection screen 500 on the display unit such as a liquid crystal display. FIG. 5 is an explanatory view illustrating an example of the option parameter selection screen 500 which the exemplary embodiment displays. In the option parameter selection screen 500, a selection area 510, option parameter names, and an explanation area 520 are displayed. In the selection area 510, a plurality of option parameters can be selected.

In STEP S208, the option parameter selecting module 120 determines whether the parameter selection has been completed. In a case where the parameter selection has been completed, the process proceeds to STEP S210, and otherwise, the process returns to STEP S206.

In STEP S210, the option-parameter-designating-method selecting module 130 selects an option parameter designating method. Examples of the designating method include the easy designation (the first method), the history designation (the second method), the registration designation (the third method), the model-dependent designation (the fourth method), and the manual designation (the fifth method). For example, the option-parameter-designating-method selecting module 130 displays an option-parameter-designating-method selection screen 600 on the display unit such as a liquid crystal display. FIG. 6 is an explanatory view illustrating an example of the option-parameter-designating-method selection screen 600 which the exemplary embodiment displays. In the option-parameter-designating-method selection screen 600, a selection area 610, the names of the designating methods, and an explanation area 620 are displayed. In the selection area 610, only one designating method can be selected.

In STEP S212, the option-parameter-designating-method selecting module 130 determines whether any designating method has been selected. In a case where a designating method has been selected, the process proceeds to STEP S214, and otherwise, the process returns to STEP S210.

In STEP S214, the paper-attribute-file generating module 140 newly generates a paper attribute file.

For example, a case where the attribute “WEIGHT OF PAPER” is selected in STEP S206, and with respect to that attribute, the first method (easy designation) is selected in STEP S210 will be described. The paper-attribute-file generating module 140 receives a range that the attribute “WEIGHT OF PAPER” can take, and the increase or decrease width of that attribute value. For example, as the range, a range of 60 (g/m²) to 350 (g/m²) is set, and as the increase width, 5 (g/m²) is set.

Since the increase width is used, the paper-attribute-file generating module 140 extracts the minimum value of the range, thereby generating the attribute value of that minimum value, and adds the increase width to the attribute value, thereby generating the next attribute value. The paper-attribute-file generating module 140 repeats that process until the next attribute value becomes the maximum value of the range, thereby generating a plurality of attribute values. Each of the generated attribute values is set as an attribute value of each paper attribute file. In a case where the decrease width is used, the paper-attribute-file generating module 140 extracts the maximum value of the range, thereby generating the attribute value of that maximum value, and subtracts the decrease width from that attribute value, thereby generating the next attribute value. The paper-attribute-file generating module 140 may repeat that process until the next attribute value becomes the minimum value of the range, thereby generating a plurality of attribute values.

In STEP S216, the paper-attribute-file generating module 140 automatically creates a name for each paper attribute file. The paper-attribute-file generating module 140 may give a name according to a predetermined rule. Examples of the rule include a rule that a generation date and time should be used as a name, a rule that the attribute value of a representative attribute (the attribute “PAPER SIZE”, the attribute “PAPER COLOR”, or the like) should be used as a name, etc. For example, like 20121211-35, the paper-attribute-file generating module 140 may create a name by combining a generation date and an attribute value (35 (g/m²)) generated by the first method (easy designation).

In STEP S218, the paper-attribute-file generating module 140 displays the list of the generated paper attribute files.

In STEP S220, the paper-attribute-file generating module 140 selects a paper attribute file to be stored. For example, there may be an unnecessary paper attribute file (such as a paper attribute file which cannot exist as an attribute combination) in the paper attribute files generated by the first method (easy designation). This paper attribute file is not selected. For example, a table including all paper attribute files capable of exiting as combinations of attribute values may be prepared in advance, and a paper attribute file corresponding to the table may be selected.

Also, the paper-attribute-file generating module 140 may display an option screen 800 representing the contents of the paper attribute file on the display unit such as a liquid crystal display. FIG. 8 is an explanatory view illustrating an example of the selection screen 800 which the exemplary embodiment displays. In the selection screen 800, a paper attribute detail display area 810, a file name display area 850, a help button 875, an OK button 880, and a cancel button 885 are displayed. The paper attribute detail display area 810 includes an attribute display area 812, a comment write area 814, and an area 816 for setting long edge feed or short edge feed. In the attribute display area 812, the attributes (attribute values) generated in STEP S214 are displayed. In the comment write area 814, comments are written by the operation of the user. The area 816 for setting long edge feed or short edge feed includes attributes which are determined by the paper feeding unit containing the papers. In the file name display area 850, the file name created in STEP S216 is displayed. In a case where the help button 875 is selected, explanations relating to attributes and the like are displayed. In a case where the OK button 880 is selected, the paper attribute file is stored in the paper-attribute-file storing module 150. In a case where the cancel button 885 is selected, the paper attribute file is deleted.

In STEP S222, the paper-attribute-file generating module 140 determines whether any file to be stored has been selected. In a case where a file has been selected, the process proceeds to STEP S224, and otherwise, the process returns to STEP S220.

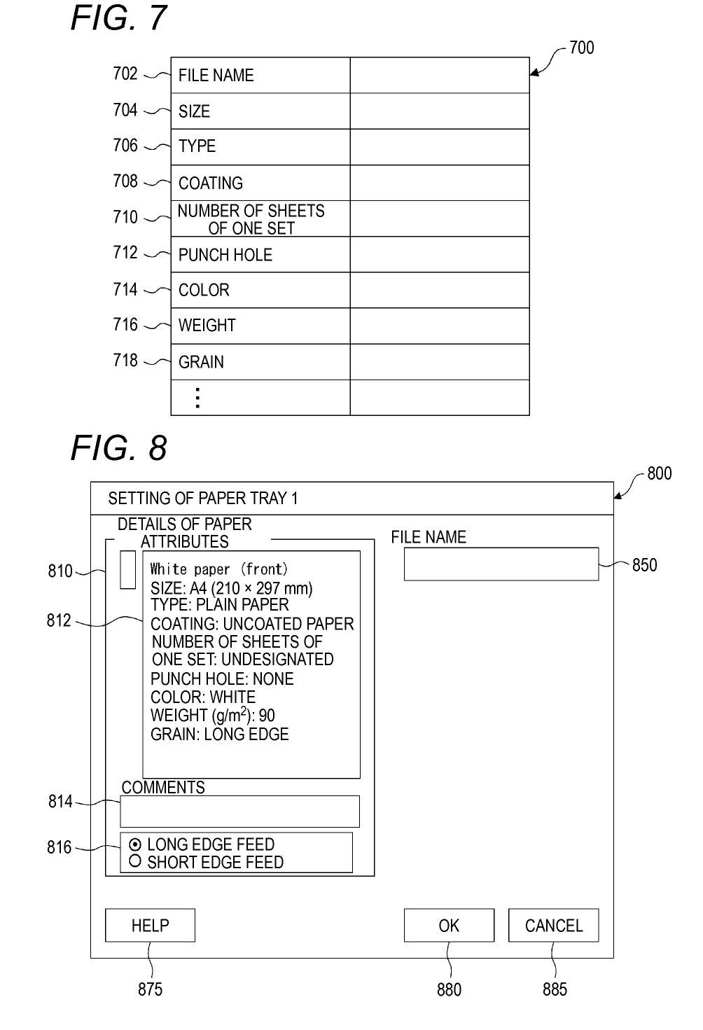

In STEP S224, the paper-attribute-file generating module 140 stores the paper attribute file in the paper-attribute-file storing module 150. For example, the content of the paper attribute file is a paper attribute table 700 having attribute values set therein. FIG. 7 is an explanatory view illustrating an example of the data structure of the paper attribute table 700. The paper attribute table 700 includes a file name section 702, a size section 704, a type section 706, a coating section 708, a section 710 for setting the number of sheets of one set, a punch hole section 712, a color section 714, a weight section 716, and a grain section 718. In those sections such as the size section 704, the attribute values generated in STEP S214 are set.

In STEP S226, it is determined whether there is any parameter to be added. In a case where there is a parameter to be added, the process proceeds to STEP S228, and otherwise, the process terminates in STEP S299.

In STEP S228, a parameter (attribute) to be added is selected. Examples of the parameter to be added include “PAPER CURL CORRECTION” (setting of a single surface or a front surface), “SECOND BIAS TRANSFER ROLL” (0% to 200% of a front surface or 0% to 200% of a rear surface as a numeral value input), “ALIGNER ROLL PRESSURE” (−40 to 40 pulses as a numeral value input), “PUSHER TEMPERATURE” (−10° C. to 200° C. as a numeral value input), “RESIDUAL PAPER AMOUNT DETECTION LEVEL” (from a small amount to a slightly small amount), “AIR ASSIST ADJUSTMENT” (an initial value, option value table No. 1, option value table No. 2, etc), and “FOLD POSITION ADJUSTMENT” (an initial value, a first option value, a second option value, etc.).

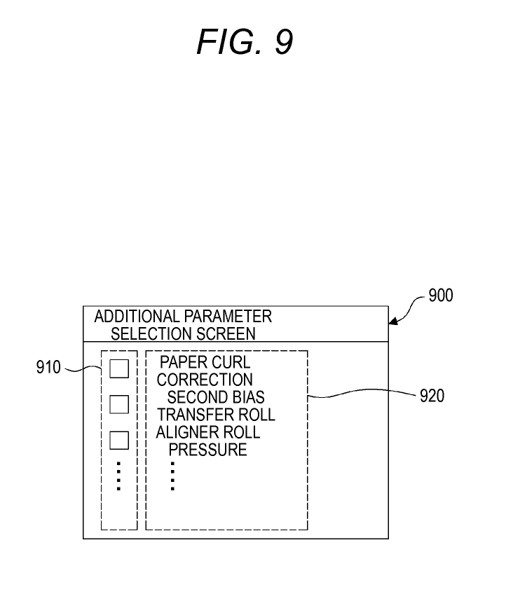

For example, an additional parameter selection screen 900 is displayed on the display unit such as a liquid crystal display. FIG. 9 is an explanatory view illustrating an example of the additional parameter selection screen 900 which the exemplary embodiment displays. In the additional parameter selection screen 900, a selection area 910, additional parameter names, and an explanation area 920 are displayed. In the selection area 910, a plurality of additional parameters can be selected.

In STEP S230, it is determined whether the parameter selection has been completed. In a case where the parameter selection has been completed, the process proceeds to STEP S232, and otherwise, the process returns to STEP S228.

In STEP S232, each selected parameter is added to the paper attribute file. Also, with respect to each additional parameter, it is possible to select any one from (1) “DON′T ADD”, (2) “AUTOMATIC SUCCESSION”, and (3) “MANUAL DESIGNATION”. Here, “AUTOMATIC SUCCESSION” is to intactly succeed to each option value added to the paper attribute file. Further, “MANUAL DESIGNATION” is to designate each option value according to the operation of the user.

In STEP S234, the paper attribute file is stored in the paper-attribute-file storing module 150.

A case where a paper attribute file is generated, and then an attribute included in the paper attribute file is changed (including updating) will be described. The following process is performed by the paper-attribute-file generating module 140.

The paper-attribute-file generating module 140 determines whether the change of that attribute makes it necessary to change another attribute. Then, in a case of determining that it is necessary to change another attribute, the paper-attribute-file generating module 140 changes another attribute on the basis of the changed attribute.

For example, in a case where a value of the attribute “PAPER COLOR” (white, gray, ivory, etc.) is changed, the paper-attribute-file generating module 140 performs the following process. (1) The paper-attribute-file generating module 140 determines whether the change of the attribute “PAPER COLOR” makes it necessary to change any other attribute. (2) Since the attribute “PAPER COLOR” is changed, the paper-attribute-file generating module 140 determines that it is unnecessary to change any other attribute. (3) The paper-attribute-file generating module 140 changes only “PAPER COLOR” in the paper attribute file.

Also, in a case where the attribute “WEIGHT OF PAPER” is changed, the paper-attribute-file generating module 140 performs the following process. (1) The paper-attribute-file generating module 140 determines whether the change of a value of the attribute “WEIGHT OF PAPER” makes it necessary to change any other attribute. (2) Since the attribute “WEIGHT OF PAPER” is changed, the paper-attribute-file generating module 140 determines that it is necessary to change any other attribute. (3) The paper-attribute-file generating module 140 extracts option parameters associated with the weight. Examples of the option parameters associated with the weight include “PAPER CURL CORRECTION” (setting of a single surface or a front surface), “SECOND BIAS TRANSFER ROLL” (0% to 200% of a front surface or 0% to 200% of a rear surface as a numeral value input), “ALIGNER ROLL PRESSURE” (−40 to 40 pulses as a numeral value input), “PUSHER TEMPERATURE” (−10° C. to 200° C. as a numeral value input), “RESIDUAL PAPER AMOUNT DETECTION LEVEL” (from a small amount to a slightly small amount), “AIR ASSIST ADJUSTMENT” (an initial value, option value table No. 1, option value table No. 2, etc), and “FOLD POSITION ADJUSTMENT” (an initial value, a first option value, a second option value, etc.). (4) The paper-attribute-file generating module 140 selects whether to automatically update or manually set the extracted option parameters. For example, the paper-attribute-file generating module 140 displays “AUTOMATIC UPDATE” and “MANUAL SETTING” on a touch panel to allow the user to select any one by an operation. (5) In a case of “AUTOMATIC UPDATE”, the paper-attribute-file generating module 140 updates values of the other attributes corresponding to the weight attribute, according to a table registered in advance. As the contents of the table registered in advance, there is a rule about how to change the value of an attribute B in a case where the attribute B corresponds to an attribute A to be changed and the value of the attribute A is changed. (6) In a case of “MANUAL SETTING”, for example, the paper-attribute-file generating module 140 sets each parameter according to the operation of the user on the touch panel. (7) In the case of “MANUAL SETTING”, it is unnecessary to manually set all paper attribute files, and the paper-attribute-file generating module 140 may reflect the attributes set in one paper attribute file to the other paper attribute files.

Examples of the attribute whose change does not make it necessary to change any other attribute include “PAPER SIZE” (A3, A4, B4, B3, 8″×10″, postcard, etc.), “PAPER COLOR” (white, gray, ivory, etc.), “COATING” (uncoated paper, coated paper, mat), “GRAIN” (long edge, and short edge), “NUMBER OF SHEETS OF ONE SET” (undesignated, and 2 to 255), and “PUNCH HOLE” (none, two holes, three holes, and four holes).

Also, examples of the attribute whose change makes it necessary to change any other attribute include “PAPER TYPE” (plain paper, OHP film, embossed paper, etc.), and “WEIGHT OF PAPER” (g/m²) (numerical values).

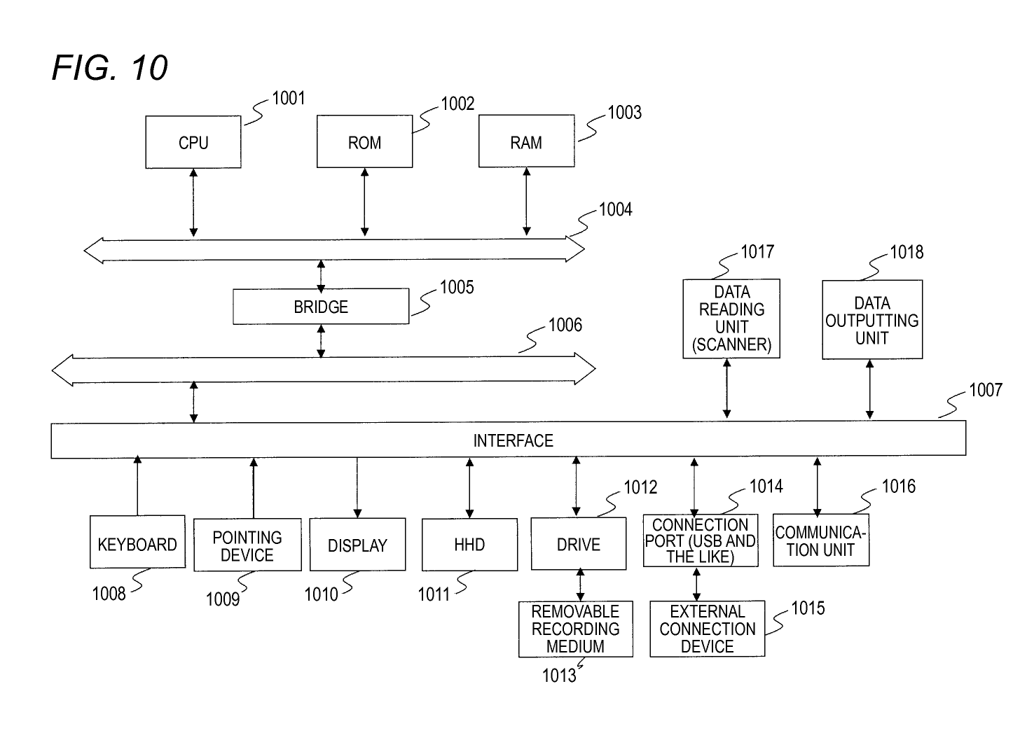

An example of the hardware configuration of the information processing apparatus of the exemplary embodiment will be described with reference to FIG. 10. The configuration shown in FIG. 10 represents an example of the hardware configuration which is configured, for example, by a personal computer (PC) or the like, and includes a data reading unit 1017 such as a scanner, and a data outputting unit 1018 such as a printer.

A central processing unit (CPU) 1001 is a control unit which performs a process according to a computer program describing an execution sequence of each of various modules such as the base file selecting module 110, the option parameter selecting module 120, the option-parameter-designating-method selecting module 130, and the paper-attribute-file generating module 140 described in the above-mentioned exemplary embodiment.

A read only memory (ROM) 1002 stores programs, operation parameters, and the like which the CPU 1001 will use. A random access memory (RAM) 1003 stores programs which are used during the operation of the CPU 1001, parameters which appropriately change in the operation of the CPU 1001, and the like. The CPU 1001, the ROM 1002, and the RAM 1003 are connected to one another by a host bus 1004 composed of a CPU bus or the like.

The host bus 1004 is connected to an external bus 1006 such as a peripheral component interconnect/interface (PCI) bus, through a bridge 1005.

A keyboard 1008 and a pointing device 1009 such as a mouse are input devices which are operated by an operator. A display 1010 is a liquid crystal display, a cathode ray tube (CRT), or the like, and displays various information as text or message information.

A hard disk drive (HDD) 1011 has a built-in hard disk, and drives the hard disk such that programs to be executed by the CPU 1001, or information is recorded or reproduced. In the hard disk, the paper attribute table 700, the paper attribute files generated by the paper-attribute-file generating module 140, paper attribute files generated in the past, and the like are stored. Further, other various computer programs such as various data processing programs are stored.

A drive 1012 reads data or programs recorded in an installed removable recording medium 1013 such as a magnetic disk, an optical disk, a magneto optical disk, or a semiconductor memory, and supplies the data or programs to the RAM 1003 connected to the drive 1012, through an interface 1007, the external bus 1006, the bridge 1005, and the host bus 1004. The removable recording medium 1013 can also be used as a data recording area like the hard disk.

A connection port 1014 is a port for connecting an external connection device 1015, and has connection portions of USB, IEEE 1394, and the like. The connection port 1014 is connected to the CPU 1001 and the like through the interface 1007, the external bus 1006, the bridge 1005, the host bus 1004, and the like. A communication unit 1016 is connected to a communication line, and performs data communication with the outside. The data reading unit 1017 is, for example, a scanner, and performs a document reading process. The data outputting unit 1018 is, for example, a printer, and performs a document data outputting process.

Also, the hardware configuration of the information processing apparatus shown in FIG. 10 is one configuration example, and the exemplary embodiment is not limited to the configuration shown in FIG. 10. Any configuration capable of implementing the modules described in the exemplary embodiment can be used. For example, some modules may be composed of dedicated hardware (for example, an application specific integrated circuit (ASIC) or the like), and some modules may be configured to be connected by a communication line included in an external system, and a plurality of systems having the same configuration as that of the system shown in FIG. 10 may be connected by a communication line such that the systems cooperate with one another. Also, the exemplary embodiment may be assembled in a copy machine, a facsimile, a scanner, a printer, a multi-function apparatus, or the like.

In the above-mentioned exemplary embodiment, with respect to one paper, a paper attribute file is generated. However, the present invention may also be used in a case of generating a paper attribute file capable of setting attributes relating to a plurality of papers (for example, a file obtained by combining paper attribute files for each of the papers).

The above-mentioned program may be stored in a recording medium or the program may be provided through communication unit. In this case, for example, the above-mentioned program may be embodied as an invention of “computer-readable recording medium having a program recorded thereon”.

The “computer-readable recording medium having a program recorded thereon” means a recording medium on which a program is recorded, which is readable by a computer, and which is used for installation, execution, and circulation of programs. Examples of the recording medium include a digital versatile disk (DVD) such as “DVD-R, DVD-RW, and DVD-RAM” of which the standard is defined in a forum for DVD and “DVD+R and DVD+RW” of which the standard is defined as DVD+RW, a compact disk (CD) such as a read only memory (CD-ROM), a CD recordable (CD-R), and a CD rewritable (CD-RW), a Blu-ray disk (a registered trademark), a magneto-optic disk (MO), a flexible disk (FD), a magnetic tape, a hard disk, a read only memory (ROM), an electrically erasable and programmable read only memory (EEPROM), a flash memory, a random access memory (RAM), a secure digital (SD) memory card, etc.

The above-mentioned program or a part thereof may be recorded in the recording medium and then may be conserved or circulated in that state. The program or a part thereof may be transmitted by communication using a transmission medium such as a wired communication network, a wireless communication network, or a combination thereof, which is used, for example, in a local area network (LAN), a metropolitan area network (MAN), a wide area network (WAN), the Internet, the Intranet, the Extranet, and the like, or may be transmitted with carrier waves.

Also, the program may be a part of another program, or may be recorded in a recording medium along with another program. The program may be distributed and recorded in plurality of recording media. The program may be recorded in any method such as compression or encryption, as long as it can be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores an attribute file which includes a plurality of attributes relating to a paper on which an image is to be printed;
a receiver that receives designations of: a first attribute from among the plurality of attributes in the stored attribute file; a range within which a value of the first attribute could be; and an increase or decrease width of the value;
a first attribute generator that generates a plurality of attribute values for the first attribute, the attribute values obtained by increasing or decreasing the value at the increase or decrease width within the range; and
a file generator that generates a plurality of attribute files, each of the generated attribute files includes each of the plurality of generated attribute values of the first attribute,
wherein an attribute value of a second attribute, which has not been designated, in the plurality of generated attribute files is the same with an attribute value of the second attribute in the attribute file.

2. The information processing apparatus according to claim 1, further comprising at least one of:
a second attribute generator that generates the plurality of attribute values on the basis of previously used attributes;
a third attribute generator that generates the plurality of attribute values using already registered attributes;
a fourth attribute generator that generates the plurality of attribute values only for a usable attribute in an image printing apparatus; and
a fifth attribute generator that generates the plurality of attribute values according to an operation of a user.

3. The information processing apparatus according to claim 2, further comprising a selector that allows a user to select at least one attribute generator which is to be used when the user instructs to generate the plurality of attribute files.

4. The information processing apparatus according to claim 1, further comprising:
a determining section that determines when a value of a third attribute in one of the plurality of generated attribute files is changed, whether it is necessary to change a value of a fourth attribute in accordance with change of the value of the third attribute; and
a changer that changes the value of the fourth attribute on the basis of the changed value of the third attribute in a case where the determining section determines that it is necessary to change the value of the fourth attribute.

5. An information processing method comprising:
storing an attribute file which includes a plurality of attributes relating to a paper on which an image is to be printed;
receiving designations of: a first attribute from among the plurality of attributes in the stored attribute file; a range within which a value of the first attribute could be; and an increase or decrease width of the value;
generating a plurality of attribute values for the first attribute, the attribute values obtained by increasing or decreasing the value at the increase or decrease width within the range; and
generating a plurality of attribute files, each of the generated attribute files includes each of the plurality of generated attribute values of the first attribute,
wherein an attribute value of a second attribute, which has not been designated, in the plurality of generated attribute files is the same with an attribute value of the second attribute in the attribute file.

6. A non-transitory computer readable medium storing a program causing a computer to execute an information processing method, the method comprising:
storing an attribute file which includes a plurality of attributes relating to a paper on which an image it to be printed;
receiving designations of: a first attribute from among the plurality of attributes in the stored attribute file; a range within which a value of the first attribute could be; and an increase or decrease width of the value;
generating a plurality of attribute values for the first attribute, the attribute values obtained by increasing or decreasing the value at the increase or decrease width within the range; and
generating a plurality of attribute files, each of the generated attribute files includes each of the plurality of generated attribute values of the first attribute,
wherein an attribute value of a second attribute, which has not been designated, in the plurality of generated attribute files is the same with an attribute value of the second attribute in the attribute file.
